(19) United States
(12) Patent Application Publication
(10) Pub. No.: US 2026/0177707 A1
(43) Pub. Date: Jun. 25, 2026

(54) POSITIONING METHOD AND POSITIONING APPARATUS

(71) Applicant: Quectel Wireless Solutions Co., Ltd., Shanghai (CN)

(72) Inventor: Zheng ZHAO, Shanghai (CN)

(73) Assignee: Quectel Wireless Solutions Co., Ltd., Shanghai (CN)

(21) Appl. No.: 19/540,519

(22) Filed: Feb. 13, 2026

Related U.S. Application Data
(63) Continuation of application No. PCT/CN2023/114785, filed on Aug. 24, 2023.

(51) Int. Cl. G01S 19/39

(52) U.S. Cl. CPC G01S 19/396

(57) ABSTRACT

A positioning method includes: obtaining a first positioning result of a to-be-positioned device; and determining a first error corresponding to the first positioning result using a first model, and determining a target positioning result for the to-be-positioned device based on the first error. The first model is used to fit a relationship between a distance and a spatial weight between the to-be-positioned device and an anchor device.

### CROSS-REFERENCE TO RELATED APPLICATIONS

This application is a continuation of International Application No. PCT/CN2023/114785, filed on Aug. 24, 2023, the disclosure of which is hereby incorporated by reference in its entirety.

### TECHNICAL FIELD

The present disclosure relates to the field of communication technology, and more particularly, to a positioning method and a positioning apparatus.

### BACKGROUND

With the development of communication technology, positioning technology based on mobile communication networks has been widely applied in the field of positioning due to its high positioning accuracy and the absence of the need for additional hardware deployment. However, in certain situations (e.g., when a to-be-positioned device is obstructed), positioning technology based on mobile communication networks is susceptible to multipath errors, which leads to a decrease in positioning accuracy. Therefore, how to improve the positioning accuracy of positioning technology based on mobile communication networks is an urgent problem that needs to be addressed.

### SUMMARY

The present disclosure provides a positioning method and a positioning apparatus. Several aspects related to the present disclosure are described below.

According to a first aspect, a positioning method is provided, the method being performed by a positioning apparatus and including: obtaining a first positioning result of a to-be-positioned device; and determining a first error corresponding to the first positioning result using a first model, and determining a target positioning result for the to-be-positioned device based on the first error; where the first model is used to fit a relationship between a distance and a spatial weight between the to-be-positioned device and an anchor device.

According to a second aspect, a positioning apparatus is provided, including: an obtaining module, obtaining a first positioning result of a to-be-positioned device; and a determining module, determining a first error corresponding to the first positioning result using a first model, and determining a target positioning result for the to-be-positioned device based on the first error; where the first model is used to fit a relationship between a distance and a spatial weight between the to-be-positioned device and an anchor device.

According to a third aspect, a positioning apparatus is provided, including: a memory and a processor, where the memory is configured to store one or more computer programs, and the processor is configured to invoke the programs in the memory to cause the positioning apparatus to perform some or all of the steps in the method according to the first aspect.

According to a fourth aspect, an embodiment of the present disclosure provides a communication system including the above positioning apparatus. In another possible design, the system further includes other devices that interact with the positioning apparatus in the solutions provided in the embodiments of the present disclosure.

According to a fifth aspect, an embodiment of the present disclosure provides a computer-readable storage medium that stores a computer program, where the computer program causes a computer to perform some or all of the steps in the method according to the first aspect.

According to a sixth aspect, an embodiment of the present disclosure provides a computer program product including a non-transitory computer-readable storage medium that stores a computer program, where the computer program is executable to cause a computer to perform some or all of the steps in the method according to the first aspect. In some implementations, the computer program product may be a software installation package.

According to a seventh aspect, an embodiment of the present disclosure provides a computer program, where the computer program is executable to cause a computer to perform some or all of the operations in the method according to the first aspect.

According to an eighth aspect, an embodiment of the present disclosure provides a chip, including a memory and a processor, where the processor is configured to invoke a computer program from the memory to implement some or all of the steps in the method according to various aspects.

In the embodiments of the present disclosure, a first model is used to fit a relationship between a distance and a spatial weight between a to-be-positioned device and an anchor device, so as to correct first positioning result based on a fitting result and obtain a more accurate positioning result (i.e., target positioning result), thereby improving positioning accuracy.

### BRIEF DESCRIPTION OF THE DRAWINGS

FIG. 1 is an example diagram of a system architecture of a wireless communication system to which an embodiment of the present disclosure may be applied.

FIG. 2 is a schematic diagram of performing positioning measurement based on the communication system shown in FIG. 1.

FIG. 3 is an example diagram of a system architecture of a positioning system to which an embodiment of the present disclosure may be applied.

FIG. 4 is a schematic flowchart of a positioning method according to an embodiment of the present disclosure.

FIG. 5 is an example diagram of a possible implementation of step S420.

FIG. 6 is a schematic flowchart of a positioning method according to another embodiment of the present disclosure.

FIG. 7 is a schematic structural diagram of a positioning apparatus according to an embodiment of the present disclosure.

FIG. 8 is a schematic structural diagram of an apparatus for communication according to an embodiment of the present disclosure.

### DETAILED DESCRIPTION OF THE EMBODIMENTS

The following describes the technical solutions in the present disclosure in combination with the attached drawings.

### Communication System Architecture

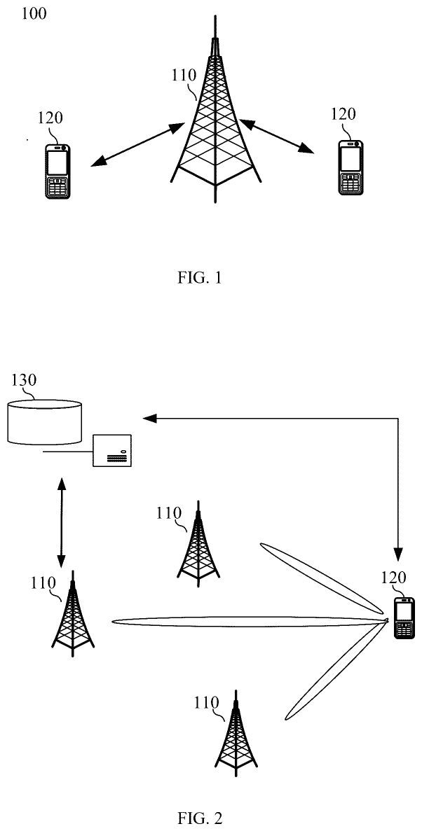

FIG. 1 is an example diagram of a system architecture of a wireless communication system 100 to which an embodiment of the present disclosure may be applied. The wireless communication system 100 may include a network device 110 and a terminal device 120, and the network device 110 may be a device that communicates with the terminal device 120. The network device 110 may provide communication coverage for a particular geographic area and communicate with the terminal device 120 located within the coverage area.

FIG. 1 exemplarily shows one network device and two terminal devices. Optionally, the wireless communication system 100 may include a plurality of network devices, and the coverage of each network device may include another quantity of terminal devices, which is not limited in the embodiments of the present disclosure.

Optionally, the wireless communication system 100 may further include another network entity such as a network controller, a mobility management entity, etc., which is not limited in the embodiments of the present disclosure.

It should be understood that the technical solutions in the embodiments of the present disclosure may be applied to various communication systems, for example, a 5th generation (5G) or new radio (NR) system, a long term evolution (LTE) system, an LTE frequency division duplex (FDD) system, an LTE time division duplex (TDD) system, and the like. The technical solutions provided in the present disclosure may further be applied to a future communication system such as a sixth-generation mobile communication system, a satellite communication system, or the like.

The terminal device in the embodiments of the present disclosure may also be referred to as user equipment (UE), an access terminal, a subscriber unit, a subscriber station, a mobile station (MS), a mobile terminal (MT), a remote station, a remote terminal, a mobile device, a user terminal, a terminal, a wireless communication device, a user agent, or a user equipment. The terminal device in the embodiments of the present disclosure may be a device that provides voice and/or data connectivity to a user, and may be used to connect a person, an object, and a machine, for example, a handheld device or a vehicle-mounted device having a wireless connection function. The terminal device in the embodiments of the present disclosure may be a mobile phone, a Pad, a notebook computer, a palmtop computer, a mobile internet device (MID), a wearable device, a virtual reality (VR) device, an augmented reality (AR) device, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in smart home, etc. Optionally, the UE may serve as a base station. For example, the UE may serve as a scheduling entity that provides a sidelink signal between UEs in vehicle-to-everything (V2X), device-to-device (D2D), or the like. For example, cellular phones and automobiles communicate with each other using sidelink signals. The cellular phone communicates with the smart home device without relaying communication signals through the base station.

The network device in the embodiments of the present disclosure may be a device configured to communicate with the terminal device, and the network device may also be referred to as an access network device or a radio access network device, such as a base station. The network device in the embodiments of the present disclosure may refer to a radio access network (RAN) node (or device) that connects the terminal device to a wireless network. The base station may broadly cover various names in the following or be replaced with the following names: for example, a node B (NodeB), an evolved NodeB (eNB), a next generation NodeB (gNB), a relay station, an access point, a transmitting and receiving point (TRP), a transmitting point (TP), a master station MeNB, a secondary station SeNB, a multistandard radio (MSR) node, a femtocell, a network controller, an access node, a wireless node, an access point (AP), a transmission node, a transceiver node, a base band unit (BBU), a remote radio unit (RRU), an active antenna unit (AAU), a remote radio unit (RRH), a central unit (CU), a distributed unit (DU), a positioning node, and the like. The base station may be a macro base station, a micro base station, a relay node, a donor node or the like, or a combination thereof.

The base station may also refer to a communication module, a modem, or a chip for being disposed in the foregoing device or apparatus. The base station may also be a mobile switching center and a device that plays a role of the base station in the D2D, vehicle-to-everything (V2X), and machine-to-machine (M2M) communication, a network side device in a 6G network, and a device that plays a role of the base station in a future communication system, etc. The base station supports networks of the same or different access technologies. The specific technology adopted by the network device and a specific form of the network device are not limited in the embodiments of the present disclosure.

The base station may be fixed or mobile. For example, a helicopter or drone may be configured to serve as a mobile base station, and one or more cells move according to the position of the mobile base station. In other examples, a helicopter or drone may be configured to serve as a device in communication with another base station.

In some deployments, the network device in the embodiments of the present disclosure may refer to the CU or the DU, or the network device includes the CU and the DU. The gNB may also include the AAU.

The network device and the terminal device may be deployed on land, including indoor or outdoor, handheld or vehicle-mounted, may be deployed on a water surface, and may also be deployed on an aircraft, a balloon, and a satellite in the air. A scenario in which the network device and the terminal device are located is not limited in the embodiments of the present disclosure.

It should be understood that all or part of functions of the communication device in the present disclosure may also be implemented by a software function running on hardware or implemented by a virtualization function instantiated on a platform (e.g., a cloud platform).

### Positioning Technology Based on Mobile Communication Network

Referring to FIG. 2, the communication system 100 may further include a positioning device 130. The positioning device 130 may be used to determine position information of a terminal device. The positioning device 130 may be located in a core network and is sometimes referred to as a location server. Taking the NR system as an example, the positioning device 130 may be a location management function (LMF). Taking other communication systems as an example, the positioning device 130 may be a location management unit (LMU), a location management center (LMC), or an evolved serving mobile location center (E-SMLC). It should be understood that the positioning device 130 may also be other network elements, nodes, or devices used to determine the position information of the terminal device, such as network elements or nodes in a future communication system for determining the position information of the terminal device. The embodiments of the present disclosure do not specifically limit the name of the positioning device.

Positioning technology based on the mobile communication network may include uplink positioning, downlink positioning, and sidelink positioning. The following takes uplink positioning and downlink positioning as examples to describe the positioning technology based on the mobile communication network.

Certain communication systems (such as NR systems) perform downlink positioning based on positioning reference signals (PRS). PRS, also known as downlink positioning reference signal (DL-PRS), is a reference signal used for positioning functions. For example, during a downlink positioning process, a terminal device 120 first measures the PRS sent by a serving cell and neighbor cells and estimates relevant information for positioning measurement. Then, the terminal device 120 may report the relevant information for positioning measurement as a measurement result of the PRS to the positioning device 130. The positioning device 130 may calculate a position of the terminal device 120 based on the relevant information for positioning measurement that is reported by the terminal device 120, thereby obtaining the position information of the terminal device 120. For example, the positioning device 130 may calculate the position information of the terminal device 120 based on a trilateration method or a triangulation method.

Certain communication systems (such as NR systems) perform uplink positioning based on a sounding reference signal (SRS). For example, during an uplink positioning process, the terminal device 120 sends the SRS. A network device 110 (the network device of the serving cell and the network device of the neighbor cells) may obtain a measurement result based on the SRS sent by the terminal device 120. The measurement result of the SRS may include relevant information for positioning measurement. Then, the network device 110 may send the relevant information for positioning measurement to the positioning device 130. The positioning device 130 may calculate the position of the terminal device 120 based on the relevant information for positioning measurement that is reported by the network device 110, thereby obtaining the position information of the terminal device 120. For example, the positioning device 130 may calculate the position information of the terminal device 120 based on a trilateration method or a triangulation method.

The above relevant information for positioning measurement may include one or more of: time information, distance information, power information, and angle information. More specifically, the relevant information for positioning measurement may include one or more of: a time difference of arrival (TDOA), an angle difference of arrival (ADOA), a reference signal receive power (RSRP), etc.

In today's society, life has begun to transition from the Internet era to the Internet of things era. With the development of IoT technology, the importance of position information is evident. Therefore, position-based positioning technology has also become a research focus. In the Internet era, positioning technology primarily focused on outdoor positioning technology. The outdoor positioning technology mainly relies on communication base stations on ground and satellites to achieve precise positioning. In the Internet of things era, in addition to the outdoor positioning technology, high-precision indoor positioning technology is also a key area of research.

In indoor positioning scenarios, traditional positioning technologies (such as a global positioning system (GPS)) do not provide ideal accuracy. This is due to interference from obstacles such as buildings, which severely disrupt traditional positioning signals (e.g., GPS signals), leading to a sharp decline in positioning accuracy. Additionally, in a complex and variable indoor environment, positioning signals may be obstructed by various obstacles, resulting in phenomena such as signal reflection and scattering, which affect signal transmission.

Currently, positioning technologies mainly applied in indoor positioning scenarios include indoor positioning technologies based on technologies such as Bluetooth, WiFi, and inertial navigation. Although these positioning technologies are widely used, they generally have relatively low positioning accuracy and require significant human and material resources for deployment.

In light of this, with the development of communication technology, the positioning technology based on the mobile communication network has gained widespread application in the positioning field due to its high accuracy and the absence of need for additional hardware deployment. For example, in indoor positioning scenarios and spatial awareness technologies, the positioning technology based on the mobile communication network is highly competitive.

However, in certain situations (e.g., when a to-be-positioned device is obstructed), the positioning technology based on the mobile communication network may also be susceptible to multipath errors, leading to decreased positioning accuracy. For example, in indoor positioning scenarios, a complex and variable indoor environment, along with obstacles such as walls and indoor objects, may obstruct the to-be-positioned device, resulting in a decline in the quality of transmission of positioning signals and, consequently, a decrease in positioning accuracy.

In this situation, how to improve the positioning accuracy of the positioning technology based on the mobile communication network is an urgent problem that needs to be addressed.

In response to the above issues, the applicant finds that a primary reason for the decrease in positioning accuracy when using the positioning technology based on the mobile communication network is the influence of multipath errors on the positioning signals during transmission. In other words, the main reason for the decrease in positioning accuracy is the multipath effect on the positioning signals during transmission. Therefore, the applicant believes that suppressing multipath errors is a key focus for improving the positioning accuracy based on the mobile communication network.

Thus, the embodiments of the present disclosure eliminate the influence of the multipath error through data modeling based on temporal and spatial regularities of multipath errors. For example, the embodiments of the present disclosure may utilize pre-existing data for modeling to determine a multipath error, and then use the determined multipath error to correct an observed value, thereby eliminating the interference of the multipath error on the positioning result.

As one possible implementation, simple polynomials or neural networks may be used for spatial interpolation fitting. However, this approach directly establishes a mapping relationship between the observed value and a true value, neglecting the spatial autocorrelation of the multipath error, which leads to poor accuracy in error modeling and, consequently, low positioning accuracy.

As another possible implementation, certain traditional spatial interpolation methods (such as inverse distance weighting interpolation, Kriging interpolation, etc.) may establish a nonlinear relationship between distances from unknown points to known points and weight coefficients corresponding to each of the distance, and then assign the determined weights to corresponding observed values to obtain prediction values of the unknown points. However, this approach has insufficient fitting capability, resulting in poor accuracy in error modeling and, thus, low positioning accuracy.

Based on this, the embodiments of the present disclosure propose to use a first model to fit a relationship between a distance and a spatial weight between the to-be-positioned device and an anchor device, and correct an initial positioning result based on a fitting result to obtain a more accurate positioning result and improve positioning accuracy.

The embodiments of the present disclosure utilize the first model to fit the relationship between the distance and spatial weight between the to-be-positioned device and the anchor device. On the one hand, the spatial autocorrelation of the multipath error is taken into account; on the other hand, the good fitting capability of the first model is leveraged, thereby improving the accuracy of error modeling and, consequently, improving positioning accuracy.

Furthermore, when the positioning technology based on the mobile communication network is used for positioning (e.g., in scenarios with obstructions) in the embodiments of the present disclosure, the installation of a large amount of additional hardware or modifications to existing hardware are not required, thus being easy to promote and offering significant advantages and application prospects in high-precision positioning scenarios (such as high-precision indoor positioning scenarios).

To facilitate understanding, an exemplary introduction to a positioning system to which the embodiments of the present disclosure may be applied is provided first.

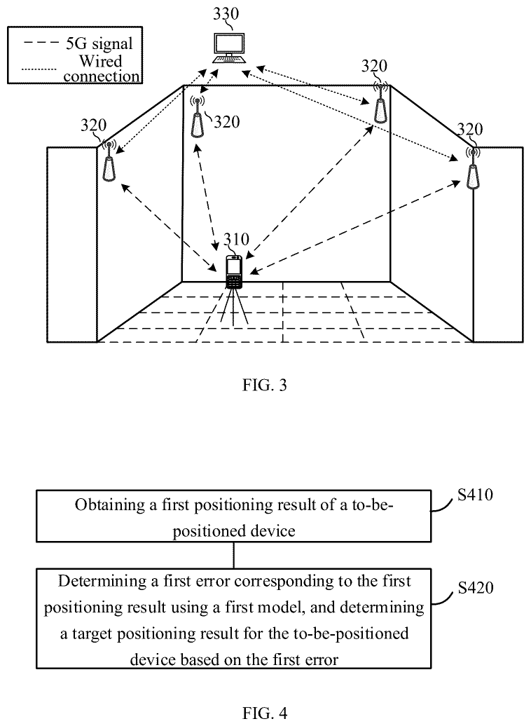

FIG. 3 is a schematic diagram of a system architecture of a positioning system applicable to the embodiments of the present disclosure. As shown in FIG. 3, the positioning system 300 may include a to-be-positioned device 310, anchor devices 320, and a server 330.

The to-be-positioned device 310 refers to a device whose position needs to be determined. In some embodiments, the to-be-positioned device 310 may also be referred to or understood as a tag. The embodiments of the present disclosure do not limit the to-be-positioned device 310, which may be any device that needs to be positioned. For example, the to-be-positioned device 310 may be a terminal device, such as the terminal device 120 shown in FIG. 1 or FIG. 2. As another example, the to-be-positioned device 310 may be an Internet of Things (IoT) device, etc.

The anchor devices 320 may assist the to-be-positioned device 310 in positioning. Positions of the anchor devices 320 are generally known or determined, allowing a position of the to-be-positioned device 310 to be determined based on the positions of the anchor devices 320 and measurement results between the anchor device 320 and the to-be-positioned devices 310.

The embodiments of the present disclosure do not specifically limit the anchor devices 320, as long as the anchor devices 320 are able to assist the to-be-positioned device 310 in positioning. As an example, the anchor devices 320 may be network devices (e.g., base stations), such as the network device 110 shown in FIG. 1 or FIG. 2, allowing the to-be-positioned device 310 and the anchor devices 320 to achieve positioning of the to-be-positioned device 310 based on uplink or downlink positioning. As another example, the anchor devices 320 may be terminal devices, such as the terminal device 320 shown in FIG. 1 or FIG. 2, allowing the to-be-positioned device 310 and the anchor devices 320 to achieve positioning of the to-be-positioned device 310 based on sidelink positioning.

In some embodiments, multiple anchor devices 320 may be present. For example, the positioning system 300 may include three or more anchor devices 320 to achieve precise positioning of the to-be-positioned device 310 based on measurement results between the to-be-positioned device 310 and different anchor devices 320.

In some embodiments, the to-be-positioned device 310 and the anchor devices 320 may communicate based on the mobile communication network, or in other words, the to-be-positioned device 310 and the anchor devices 320 may communicate based on mobile communication network signals. For example, the to-be-positioned device 310 and the anchor devices 320 may communicate based on 4G, 5G, or future mobile communication networks.

In some embodiments, the anchor devices 320 may be positioning reference units (PRU) defined in related technologies. In some embodiments, PRUs may also be referred to as positioning reference apparatuses.

In some embodiments, PRUs located at known positions may perform positioning measurements (such as time of arrival (TOA) measurements) and send measurement reports to a location server (also referred to as a position server, such as LMF).

In some embodiments, the location server may compare a measurement value of the PRU with an expected measurement value of the PRU at a known position to determine a correction term for other target devices (such as the to-be-positioned device 310).

Subsequently, position measurement values of the other target devices may be corrected based on the correction term. In some embodiments, from the perspective of the location server, the function of the PRU may be realized by a terminal device at a known position.

The server 330 may perform data analysis and processing to determine the positioning result of the to-be-positioned device 310. For example, the server 330 analyzes and processes positioning data collected by the to-be-positioned device 310 and the anchor devices 320 to determine an initial positioning result of the to-be-positioned device 310 based on the positioning data; and/or the server 330 may fit the relationship between the distance and spatial weight between the to-be-positioned device 310 and the anchor devices 320, and correct the initial positioning result of the to-be-positioned device 310 based on a fitting result to obtain a final positioning result for the to-be-positioned device 310.

In some embodiments, the server 330 may also be referred to or understood as a data processing device or data processing terminal.

The embodiments of the present disclosure do not limit the server 330. In some embodiments, the server 330 may be an independent server. In some embodiments, the server 330 may be a server group, such as a centralized server group or a distributed server group. In some embodiments, the server 330 may operate on a cloud platform. In some embodiments, the server 330 may refer to a location server (such as IMF) in the core network.

The embodiments of the present disclosure do not limit connection methods between the server 330 and other devices. For example, the to-be-positioned device 310 may connect to the server 330 via wired (such as USB interface) or wireless (such as WiFi, Bluetooth) methods to provide the collected positioning data to the server 330. For another example, the anchor devices 320 may connect to the server 330 via wired (such as network cable, fiber optic, etc.) or wireless (such as WiFi, Bluetooth, mobile network) methods to provide the collected positioning data to the server 330.

On the basis of the introduction to the positioning system to which the present disclosure is applied, the following describes a positioning method according to the present disclosure.

FIG. 4 is a schematic flowchart of a positioning method according to an embodiment of the present disclosure. The method shown in FIG. 4 may be performed by a positioning apparatus, e.g., performed by the server 330 shown in FIG. 3. Alternatively, in some embodiments, the method shown in FIG. 4 may be performed by a device with data analysis and processing capabilities.

The positioning method according to the embodiment of the present disclosure is applicable to various positioning scenarios, which is not limited in the present disclosure. For example, the positioning method may be applied to indoor positioning scenarios. Alternatively, the positioning method may be applied to outdoor positioning scenarios. Alternatively, the positioning method may be applied to positioning scenarios with obstructions, etc.

The method shown in FIG. 4 may include steps S410 and S420, which are introduced below.

In step S410, a first positioning result of a to-be-positioned device is obtained.

In some embodiments, the first positioning result is determined using the positioning technology based on the mobile communication network. In other words, the first positioning result is associated with the positioning technology based on the mobile communication network.

The embodiments of the present disclosure do not limit the positioning technology based on the mobile communication network. Exemplarily, the positioning technology based on the mobile communication network may include a 5G positioning technology, meaning that the embodiments of the present disclosure may utilize the 5G positioning technology to determine the first positioning result. However, the embodiments of the present disclosure are not limited thereto, the positioning technology based on the mobile communication network may also include a 4G positioning technology, or the positioning technology based on the mobile communication network involved in future communication systems (e.g., 6G positioning technology), etc.

In some embodiments, the positioning technology based on the mobile communication network may include positioning based on signal strength, such as positioning based on RSRP.

In some embodiments, the positioning technology based on the mobile communication may include positioning based on signal arrival time, such as positioning based on TOA. In some embodiments, the positioning technology based on the mobile communication may include fingerprint database positioning.

In some embodiments, the first positioning result is determined based on positioning data collected by the to-be-positioned device and anchor devices. For example, the to-be-positioned device and the anchor devices may collect positioning data using the positioning technology based on the mobile communication network. For example, the to-be-positioned device and the anchor devices may communicate using 5G signals to achieve data exchange so as to obtain the positioning data.

In some embodiments, the first positioning result is determined based on first positioning data, and the first positioning data is obtained by filtering the positioning data collected by the to-be-positioned device and the anchor devices. The first positioning data is introduced in the following, which is not elaborated here for brevity.

In some embodiments, the to-be-positioned device and the anchor devices may utilize uplink positioning to collect positioning data. For example, the to-be-positioned device may send the SRS, and the anchor devices (e.g., a plurality of network devices) may obtain measurement results based on the SRS sent by the to-be-positioned device, where the measurement results of the SRS may include the above positioning data.

In some embodiments, the to-be-positioned device and the anchor devices may utilize downlink positioning to collect positioning data. For example, the to-be-positioned device may measure DL-PRSs sent by the anchor devices (e.g., a plurality of network devices) and estimate the above positioning data based on the measurement results of the DL-PRSs.

In some embodiments, the to-be-positioned device and the anchor devices may utilize sidelink positioning to collect positioning data. For example, the to-be-positioned device may measure SL-PRSs sent by the anchor devices (e.g., a plurality of terminal devices) and estimate the above positioning data based on the measurement results of the SL-PRSs. Alternatively, the to-be-positioned device may send the SL-PRS, and the anchor devices (e.g., a plurality of terminal devices) may obtain a measurement result based on the SL-PRS sent by the to-be-positioned device, where the measurement result of the SL-PRS may include the above positioning data.

The embodiments of the present disclosure do not limit the positioning data collected by the to-be-positioned device and the anchor devices. In some embodiments, the positioning data collected by the to-be-positioned device and the anchor devices may include a time of arrival (TOA), or in other words, the above positioning data may be obtained using a TOA positioning method. However, the embodiments of the present disclosure are not limited thereto. For example, the above positioning data may include one or more of: a time difference of arrival (TDOA), an angle difference of arrival (ADOA), an angle of arrival (AOA), etc. In other words, the above positioning data may be obtained using one or more of the following positioning methods: TDOA, ADOA, AOA, etc.

In some embodiments, after obtaining the above positioning data (such as TOA data), the to-be-positioned device or the anchor device may send the positioning data to the server.

In some embodiments, the server obtaining the first positioning result refers to the server determining the first positioning result based on the positioning data sent by the to-be-positioned device or the anchor device. However, the embodiments of the present disclosure are not limited thereto. In some embodiments, the server obtaining the first positioning result may also refer to the server obtaining the first positioning result from another device (such as LMF).

In some embodiments, the first positioning result is determined based on a Newton's method (also known as Newton's iterative method). The Newton's method can converge quickly, and using the Newton's method to determine the first positioning result can thus improve the calculation speed while ensuring the accuracy of the result. The details of how to determine the first positioning result based on the Newton's method are introduced below, which are not elaborated here.

The embodiments of the present disclosure are not limited to using the Newton's method to determine the first positioning result. For example, the embodiments of the present disclosure may determine the first positioning result using one or more of: a Lagrange interpolation method, a Gaussian elimination method, a gradient descent method, a quasi-Newton method, etc.

In step S420, a first error corresponding to the first positioning result is determined using a first model, and a target positioning result for the to-be-positioned device is determined based on the first error.

In the embodiments of the present disclosure, the first model may be used to fit (or estimate) the relationship between the distance and spatial weight between the to-be-positioned device and the anchor device. In other words, the first model may be used to estimate the spatial weight corresponding to the distance between the to-be-positioned device and the anchor device.

In some embodiments, the relationship between the distance and spatial weight between the to-be-positioned device and the anchor device may be a nonlinear relationship. That is to say, the first model may be used to fit the nonlinear relationship between the distance and spatial weight between the to-be-positioned device and the anchor device.

In some embodiments, the relationship between the distance and spatial weight between the to-be-positioned device and the anchor device may be used to indicate the spatial correlation between the to-be-positioned device and the anchor device. In other words, the spatial correlation between the to-be-positioned device and the anchor device may be regarded as the nonlinear relationship between the distance and spatial weight between the to-be-positioned device and the anchor device.

In some embodiments, the distance between the to-be-positioned device and the anchor device may be an input of the first model, and the spatial weight between the to-be-positioned device and the anchor device may be an output of the first model.

In some embodiments, the distance between the to-be-positioned device and the anchor device may be an input of the first model, the spatial weight between the to-be-positioned device and the anchor device may be an intermediate variable of the first model, and the first error may be an output of the first model.

The embodiments of the present disclosure do not limit the first model, as long as the first model can fit the relationship between the distance and spatial weight between the to-be-positioned device and the anchor device. Exemplarily, the first model may be an artificial intelligence (AI) model or a machine learning (ML) model.

In some embodiments, the first model may be a neural network model, for example, the first model may be a spatial neural network model. When using the neural network model to fit the relationship between the distance and spatial weight between the to-be-positioned device and the anchor device, the fitting capability of the neural network model is strong, and the fitting accuracy is high, which is beneficial for improving positioning accuracy. The reason why the neural network model (such as the spatial neural network model) is capable of modeling the multipath error is that, in situations where the to-be-positioned device is obstructed (e.g., when the to-be-positioned device is indoors), electromagnetic signals may experience multipath effects due to reflection and scattering from objects during propagation, and the multipath error is thus spatially correlated. As a result, the embodiments of the present disclosure may use a small quantity of observation points to predict multipath errors of unknown points, correct observed values, and ensure that the fitted multipath errors have high accuracy, thereby improving positioning accuracy.

In the embodiments of the present disclosure, the first error may be used to indicate the error caused by the multipath effect during the transmission of positioning signals. In other words, the first error may be used to indicate a transmission error caused by phenomena such as reflection and scattering during the transmission of positioning signals. Therefore, in some embodiments, the first error may also be referred to or understood as the multipath error.

In the embodiments of the present disclosure, the first model may be used to determine the first error corresponding to the first positioning result, meaning that the embodiments of the present disclosure may fit the relationship between the distance and spatial weight between the to-be-positioned device and the anchor device using the first model, to determine the first error based on the fitting result, so as to subsequently correct the first positioning result of the to-be-positioned device based on the first error.

In some embodiments, after determining the first error in the embodiments of the present disclosure, the target positioning result for the to-be-positioned device may be determined based on the first error. As a possible implementation, after determining the first error in the embodiments of the present disclosure, the first error may be used to compensate for the positioning data collected by the to-be-positioned device or the anchor device, in order to determine the target positioning result for the to-be-positioned device based on the compensated positioning data. In other words, in the embodiments of the present disclosure, the first model may be used to determine the first error, and the first error may be used to compensate for the positioning data collected by the to-be-positioned device or the anchor device, in order to determine the target positioning result for the to-be-positioned device based on the compensated positioning data. In this way, the target positioning result determined in the embodiments of the present disclosure eliminates the influence of the multipath error, which is beneficial for improving positioning accuracy.

The following describes a possible implementation of step S420 in conjunction with FIG. 5. Referring to FIG. 5, step S420 may include steps S422 and S424.

In step S422, first positioning data corresponding to the first positioning result is compensated based on the first error to obtain second positioning data.

In some embodiments, the first positioning data corresponding to the first positioning result may be understood as the first positioning data used to determine the first positioning result. In other words, the first positioning result may be obtained based on the first positioning data.

In some embodiments, the first positioning data may be the positioning data collected by the to-be-positioned device and the anchor device.

In some embodiments, the first positioning data may be obtained by filtering the positioning data collected by the to-be-positioned device and the anchor device. That is to say, the first positioning data may be the filtered positioning data, or the first positioning data may be the positioning data with noise removed.

The embodiments of the present disclosure do not limit implementation methods for removing noise from the positioning data collected by the to-be-positioned device and the anchor device. As a possible implementation, empirical mode decomposition may be used to remove noise from the positioning data collected by the to-be-positioned device and the anchor device. As another possible implementation, a Kalman filter may be used to remove noise from the positioning data collected by the to-be-positioned device and the anchor device. As yet another possible implementation, Gaussian filtering may be used to remove noise from the positioning data collected by the to-be-positioned device and the anchor device, etc.

In step S424, the target positioning result for the to-be-positioned device is determined using the second positioning data.

The embodiments of the present disclosure do not limit implementation methods for determining the target positioning result using the second positioning data. In some embodiments, the implementation method for determining the target positioning result using the second positioning data may be the same as the implementation method for determining the first positioning result using the first positioning data. For example, in the embodiments of the present disclosure, the Newton's method may be used to process the second positioning data to determine the target positioning result, and similarly, the Newton's method may also be used to process the first positioning data to determine the first positioning result. In some embodiments, the implementation method for determining the target positioning result using the second positioning data may differ from the implementation method for determining the first positioning result using the first positioning data. For example, in the embodiments of the present disclosure, the Newton's method may be used to process the second positioning data to determine the target positioning result, while the Lagrange interpolation method may be used to process the first positioning data to determine the first positioning result.

In the embodiments of the present disclosure, the first error may be determined based on one or more factors. Exemplarily, the first error may be determined based on one or more of: the distance between the to-be-positioned device and the anchor device, the spatial weight between the to-be-positioned device and the anchor device, and an observation error corresponding to the first positioning result. As one example, the first error may be determined based on the spatial weight between the to-be-positioned device and the anchor device, as well as the observation error corresponding to the first positioning result. As another example, the first error may be determined based on the distance between the to-be-positioned device and the anchor device, the spatial weight between the to-be-positioned device and the anchor device, and the observation error corresponding to the first positioning result.

As a possible implementation, the first error may be determined according to formula (1): PGP

$${e}_{unkown} = f ( d ) {e}^{T} \qquad ( 1 )$$

where e_{unkown} represents the first error, f(d) represents the relationship between the distance and the spatial weight between the to-be-positioned device and the anchor device, e represents an observation error vector corresponding to the first positioning result, and e^{T} represents a transposed matrix of e.

In some embodiments, f(d), which represents the relationship between the distance and spatial weight between the to-be-positioned device and the anchor device, may also be understood as a nonlinear mapping from the distance between the to-be-positioned device and the anchor device to the spatial weight between the to-be-positioned device and the anchor device, where d represents the distance (i.e., a distance vector) between the to-be-positioned device and the anchor device.

The embodiments of the present disclosure do not limit the method for determining the observation error vector corresponding to the first positioning result. Exemplarily, the observation error vector may be determined based on the distance between the to-be-positioned device and the anchor device, as well as the positioning data collected by the to-be-positioned device and the anchor device. As one example, the observation error vector may be determined based on the distance between the to-be-positioned device and the anchor device, as well as the positioning data collected by the to-be-positioned device and the anchor device. As another example, the observation error vector may be determined based on the distance between the to-be-positioned device and the anchor device, as well as the positioning data obtained by filtering the positioning data collected by the to-be-positioned device and the anchor device.

As a possible implementation, the observation error vector may equal the distance between the to-be-positioned device and the anchor device minus the positioning data collected by the to-be-positioned device and the anchor device. In some embodiments, necessary unit conversions may be carried out when performing the subtraction operation between the distance between the to-be-positioned device and the anchor device and the positioning data collected by the to-be-positioned device and the anchor device. As another possible implementation, the observation error vector may equal the distance between the to-be-positioned device and the anchor device minus the filtered positioning data collected by the to-be-positioned device and the anchor device.

In some embodiments, to establish a model that fits the relationship between the multipath error for the to-be-positioned device (unknown point) and the multipath error for the anchor device (known point), the nonlinear relationship between the spatial weight and spatial distance for an i^{th} unknown point may be expressed using formula (2):

$${w}_{i} = ( {w}_{i 1} , {w}_{i 2} , … , {w}_{in} ) = f ( {d}_{i 1} , {d}_{i 2} , … , {d}_{in} ) \qquad ( 2 )$$

where wᵢ represents a spatial weight vector for the i^{th} unknown point, wᵢⱼ represents a spatial weight between the i^{th} point and a j^{th} point, dᵢⱼ represents a distance between the i^{th} point and the j^{th} point, j is less than or equal to n, and n represents a number of known points (e.g., a number of anchor devices).

In some embodiments, to characterize the nonlinear relationship between the distance and spatial weight between the to-be-positioned device and the anchor device, a spatial neural network model (such as a spatial autoregressive neural network model) may be used to fit the above wᵢ. As a possible implementation, the input of the spatial neural network model may be the distance between the to-be-positioned device and the anchor device, and the output may be the spatial weight between the to-be-positioned device and the anchor device.

The embodiments of the present disclosure do not limit the spatial neural network, which may be any neural network model capable of fitting the relationship between the distance and spatial weight between the to-be-positioned device and the anchor device. In some embodiments, the spatial neural network model may be a multilayer fully connected neural network model. For example, the number of layers in the spatial neural network model may be three or more. In some embodiments, the number of neurons in each layer of the spatial neural network model may be equal to the number of input distances.

In some embodiments, the above first error may be obtained by multiplying the spatial weight between the to-be-positioned device and the anchor device with the observation vector corresponding to the first positioning result. For example, the first error may be determined according to formula (3):

$${e}_{unkown} = SANN ( {d}_{i 1} , {d}_{i 2} , … , {d}_{in} ) {e}^{T} \qquad ( 3 )$$

where e_{unkown} represents the first error, dᵢⱼ represents a distance between an i^{th} point and a j^{th} point, j is less than or equal to n, n represents a number of known points (e.g., the number of anchor devices), SANN represents the spatial neural network, e represents the observation error vector corresponding to the first positioning result, and e^{T} represents a transposed matrix of e.

As mentioned above, the first positioning result may be determined based on the Newton's method. The following describes how to determine the first positioning result based on the Newton's method.

As one implementation, the server may use TOA data collected by the to-be-positioned device and the anchor device to obtain distance data between the to-be-positioned device and the anchor device, and then process the distance data using the Newton's method to obtain the first positioning result.

In some embodiments, the distance between the to-be-positioned device and the anchor device may be equal to a product of the collected TOA data and the speed of light.

In some embodiments, the distance between the to-be-positioned device and the anchor device may be expressed using formula (4):

$$\sqrt{{( x - {x}_{i} )}^{2} + {( y - {y}_{i} )}^{2} + {( z - {z}_{i} )}^{2}} = {d}_{i} \qquad ( 4 )$$

where (x, y, z) represents the first positioning result (coordinates to be determined) of the to-be-positioned device, (xᵢ, yᵢ, zᵢ) represents position coordinates of an i^{th} anchor device, and dᵢ represents a distance between the to-be-positioned device and the i^{th} anchor device.

In some embodiments, the formula (4) may be transformed or rewritten as formula (5):

$$\sqrt{{( x - {x}_{i} )}^{2} + {( y - {y}_{i} )}^{2} + {( z - {z}_{i} )}^{2}} - {d}_{i} = 0 \qquad ( 5 )$$

Let the left side of formula (5) be fᵢ, and then the vector F determined based on the distances between the to-be-positioned device and different anchor devices may be expressed as F=[₁f, f₂, . . . , fᵢ, . . . ].

A Jacobian matrix F′ of the vector F may be determined using formula (6):

$${F}^{′} = [ \begin{matrix}\frac{\partial {f}_{1}}{\partial x} & \frac{\partial {f}_{1}}{\partial y} & \frac{\partial {f}_{2}}{\partial z} \\ \frac{\partial {f}_{2}}{\partial x} & \frac{\partial {f}_{2}}{\partial y} & \frac{\partial {f}_{2}}{\partial z} \\ \frac{\partial {f}_{3}}{\partial x} & \frac{\partial {f}_{3}}{\partial y} & \frac{\partial {f}_{3}}{\partial z} \\ … & … & …\end{matrix} ] \qquad ( 6 )$$

Taking a positioning system with four anchor devices as an example, the above formula (5) may include the following four equations:

$$\sqrt{{( x - {x}_{1} )}^{2} + {( y - {y}_{1} )}^{2} + {( z - {z}_{1} )}^{2}} - {d}_{1} = 0$$

$$\sqrt{{( x - {x}_{2} )}^{2} + {( y - {y}_{2} )}^{2} + {( z - {z}_{2} )}^{2}} - {d}_{2} = 0$$

$$\sqrt{{( x - {x}_{3} )}^{2} + {( y - {y}_{3} )}^{2} + {( z - {z}_{3} )}^{2}} - {d}_{3} = 0$$

$$\sqrt{{( x - {x}_{4} )}^{2} + {( y - {y}_{4} )}^{2} + {( z - {z}_{4} )}^{2}} - {d}_{4} = 0$$

Let the left sides of these four equations be f₁, f₂, f₃, and f₄, respectively, and then the vector F may be expressed as F=[f₁, f₂, f₃, f₄], and the Jacobian matrix F′ corresponding to F may be expressed using formula (7):

$${F}^{′} = [ \begin{matrix}\frac{\partial {f}_{1}}{\partial x} & \frac{\partial {f}_{1}}{\partial y} & \frac{\partial {f}_{2}}{\partial z} \\ \frac{\partial {f}_{2}}{\partial x} & \frac{\partial {f}_{2}}{\partial y} & \frac{\partial {f}_{2}}{\partial z} \\ \frac{\partial {f}_{3}}{\partial x} & \frac{\partial {f}_{3}}{\partial y} & \frac{\partial {f}_{3}}{\partial z} \\ \frac{\partial {f}_{4}}{\partial x} & \frac{\partial {f}_{4}}{\partial y} & \frac{\partial {f}_{4}}{\partial z}\end{matrix} ] \qquad ( 7 )$$

In some embodiments, when determining the first positioning result using the Newton's method, the first positioning result may be determined based on formula (8):

$${x}^{( k + 1 )} = {x}^{( k )} + Δ {x}^{( k )} \qquad ( 8 )$$

where x^{(k+1)} is the first positioning result obtained in a next iteration, x^{(k)} is the first positioning result obtained in a current iteration, Δx^{(k)} is an updated error for the current iteration, and k is a number of iterations.

The updated error for the current iteration Δx^{(k)} is determined according to formula (9):

$$Δ {x}^{( k )} = {( {F}^{′} ( {x}^{( k )} ) )}^{- 1} \cdot ( - F ( {x}^{( k )} ) ) \qquad ( 9 )$$

where F(x(^{k})) is a vector determined by the distance between the to-be-positioned device and the anchor device, and (F′(x(k))⁻¹ is an inverse of a Jacobian matrix of F(x(^{k})).

It should be understood that F(x(^{k})) may be determined from the vector F mentioned above, and the vector (F′(x(k)))⁻¹ may be determined using formula (7) mentioned above.

In some embodiments, in addition to using the Jacobian matrix mentioned above to calculate a gradient of an objective function to determine the first positioning result, other methods may also be used to calculate the gradient of the objective function to assist in determining the first positioning result. For example, in the embodiments of the present disclosure, other methods such as a finite difference method, an automatic differentiation method, a forward difference method may be used to calculate the gradient of the objective function to determine the first positioning result, which is not limited in the embodiments of the present disclosure.

In some embodiments, before determining the first error using the first model, the first model may be trained using training data (also referred to as prior data).

In some embodiments, a coordinate system may be established for the environment (e.g., an indoor environment) where the to-be-positioned device is located to collect training data used for training the first model. As one implementation, the environment where the to-be-positioned device is located may be divided into grid areas, and positioning data (such as TOA data) may be collected at intersection points of the grid as training data for training the first model.

In some embodiments, the positions at the intersection points of the grid may be measured using a laser rangefinder. However, the embodiments of the present disclosure are not limited thereto, the positions at the intersection points of the grid may also be obtained using other methods capable of measuring position information.

In some embodiments, before training the first model with the collected positioning data, the collected positioning data may be processed to obtain a data format that conforms to network input. Subsequently, parameters of the first model may be adjusted based on the processed positioning data, and an optimal first model may be obtained through multiple times of training.

In some embodiments, the position of the anchor device is known. In some embodiments, the position of the anchor device may be measured using the laser rangefinder. However, the embodiments of the present disclosure are not limited thereto, the position of the anchor device may also be obtained using other methods capable of measuring position information.

In some embodiments, the positioning apparatus may notify the parameters of the first model to the to-be-positioned device or the anchor device to facilitate positioning estimation by the to-be-positioned device or the anchor device. For example, after the positioning apparatus notifies the parameters of the first model to the to-be-positioned device or the anchor device, the to-be-positioned device or the anchor device may perform local positioning estimation based on the parameters of the first model to determine the target positioning result for the to-be-positioned device.

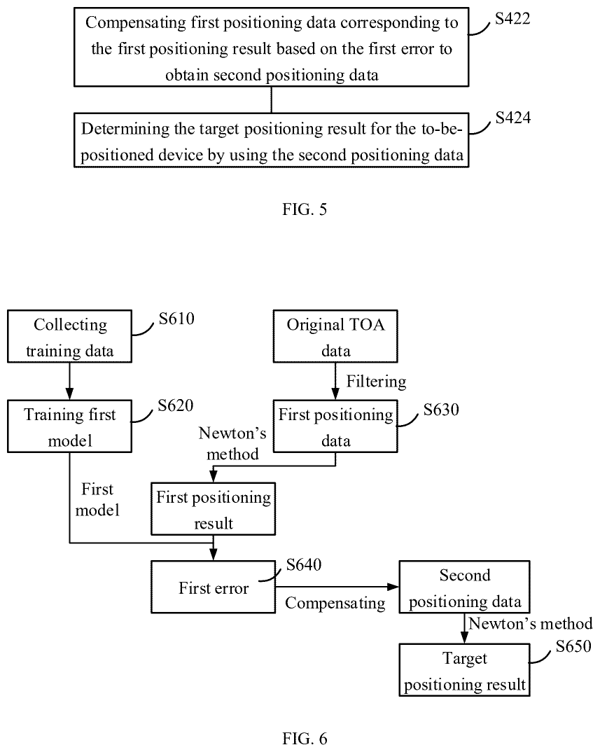

To facilitate understanding, the following provides a specific example of the embodiments of the present disclosure in conjunction with FIG. 6, which serves as an exemplary introduction to the steps of the method embodiments of the present disclosure.

It should be noted that this example is introduced using 5G positioning technology for positioning. Content not detailed in this example may be referenced in the relevant descriptions provided above.

FIG. 6 is a schematic flowchart of a positioning method according to another embodiment of the present disclosure. The method shown in FIG. 6 is introduced from the perspective of the interaction among various devices included in the positioning system. The method shown in FIG. 6 may include steps S610 to S650.

In step S610, the server collects training data for the first model.

As one implementation, the indoor environment may be divided into grid areas, and TOA data may be collected at the intersection points of the grid as training data for training the first model.

In some embodiments, the training data collected by the server may refer to training data sent to the server by other devices (such as anchor devices).

In step S620, the server trains the first model.

In some embodiments, the server may process the collected training data to obtain a data format that conforms to the network input.

In some embodiments, the server may train the first model based on the processed training data. For example, the server may adjust network training parameters to train and obtain the optimal first model.

In step S630, the server filters the collected positioning data to obtain the first positioning data (i.e., the filtered positioning data).

In some embodiments, after the to-be-positioned device and the anchor device communicate based on 5G signals to collect positioning data, the collected positioning data may be sent to the server. Subsequently, the server may filter the positioning data collected by the to-be-positioned device and the anchor device to filter out noise from the positioning data so as to obtain the first positioning data.

As one implementation, the server may use empirical mode decomposition to filter the positioning data collected by the to-be-positioned device and the anchor device.

In step S640, the server uses the first model to determine the first error corresponding to the first positioning result.

In some embodiments, the server may determine the first positioning result based on the first positioning data, e.g., using the Newton's method to process the first positioning data to determine the first positioning result.

In some embodiments, the server may input the first positioning result into the first model to determine the first error.

In some embodiments, after determining the first error, the server may use the first error to correct (or compensate) the first positioning data to obtain second positioning data (i.e., the corrected positioning data).

In step S650, the server determines the target positioning result for the to-be-positioned device based on the second positioning data.

As one implementation, the server may utilize the Newton's method and the second positioning data to determine the target positioning result for the to-be-positioned device, thereby improving the accuracy of the positioning.

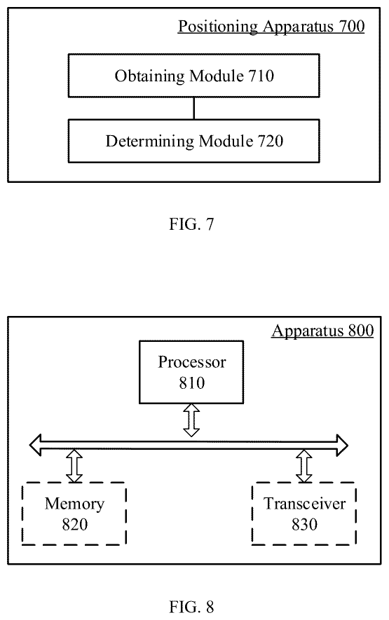

The method embodiments of the present disclosure are described in detail above with reference to FIG. 1 to FIG. 6. Apparatus embodiments of the present disclosure are described in detail below with reference to FIG. 7 to FIG. 8. It should be understood that the descriptions of the apparatus embodiments correspond to the descriptions of the method embodiments, and therefore, reference may be made to the foregoing method embodiments for parts that are not described in detail.

FIG. 7 is a schematic structural diagram of a positioning apparatus according to an embodiment of the present disclosure. The positioning apparatus 700 shown in FIG. 7 may be any server mentioned above, such as the server 330. Alternatively, the positioning apparatus 700 shown in FIG. 7 may be applied to any server mentioned above, for example, the positioning apparatus 700 is a component on the server 330.

The positioning apparatus 700 may include an obtaining module 710 and a determining module 720.

The obtaining module 710 may be configured to obtain a first positioning result of a to-be-positioned device.

The determining module 720 may be configured to determine a first error corresponding to the first positioning result using a first model, and determine a target positioning result for the to-be-positioned device based on the first error; where the first model is used to fit a relationship between a distance and a spatial weight between the to-be-positioned device and an anchor device.

Optionally, the first error is determined according to one or more of: the distance between the to-be-positioned device and the anchor device, the spatial weight between the to-be-positioned device and the anchor device, and an observation error corresponding to the first positioning result.

Optionally, the first error is determined according to the following formula:

$${e}_{unkown} = f ( d ) {e}^{T}$$

where e_{unkown} represents the first error, f(d) represents the relationship between the distance and the spatial weight between the to-be-positioned device and the anchor device, e represents an observation error vector corresponding to the first positioning result, and e^{T} represents a transposed matrix of e.

Optionally, the observation error vector e is determined according to the distance between the to-be-positioned device and the anchor device and positioning data collected by the to-be-positioned device and the anchor device.

Optionally, the determining module is configured to: compensate first positioning data corresponding to the first positioning result based on the first error to obtain second positioning data; and determine the target positioning result using the second positioning data.

Optionally, the first positioning data is obtained by filtering positioning data collected by the to-be-positioned device and the anchor device.

Optionally, the positioning data collected by the to-be-positioned device and the anchor device is obtained using a time of arrival (TOA) positioning method.

Optionally, the target positioning result is determined according to the following formula:

$${x}^{( k + 1 )} = {x}^{( k )} + Δ {x}^{( k )} ,$$

where x^{(k+1)} is the target positioning result obtained in a next iteration, x^{(k)} is the target positioning result obtained in a current iteration, Δx^{(k)} is an updated error for the current iteration, and k is a number of iterations; and the updated error Δx^{(k)} for the current iteration is determined according to a formula:

$$Δ {x}^{( k )} = {( {F}^{′} ( {x}^{( k )} ) )}^{- 1} \cdot ( - F ( {x}^{( k )} ) )$$

where F(x(^{k})) is a vector determined based on the distance between the to-be-positioned device and the anchor device, and (F′(x(^{k}))⁻¹ is an inverse of a Jacobian matrix of F(x(^{k})).

Optionally, the first model is a spatial neural network model.

Optionally, the first positioning result is determined using a positioning technology based on a mobile communication network.

Optionally, the positioning apparatus is used for indoor positioning.

Optionally, the positioning apparatus further includes a notification module, notifying parameters of the first model to the to-be-positioned device or the anchor device, where the parameters of the first model are used for the to-be-positioned device or the anchor device to perform positioning estimation.

FIG. 8 is a schematic structural diagram of an apparatus for communication according to an embodiment of the present disclosure. The dashed line in FIG. 8 indicates that the unit or module is optional. The apparatus 800 may be configured to implement the method described in the foregoing method embodiments. The apparatus 800 may be a chip, a server, a terminal device, or a network device.

The apparatus 800 may include one or more processors 810, and the processor 810 may support the apparatus 800 to implement the method described in the foregoing method embodiments. The processor 810 may be a general-purpose processor or a dedicated processor. For example, the processor may be a central processing unit (CPU). Alternatively, the processor may be another general-purpose processor, a digital signal processor (DSP), an application specific integrated circuit (ASIC), a field programmable gate array (FPGA) or other programmable logic devices, a discrete gate or transistor logic device, a discrete hardware component, or the like. The general-purpose processor may be a microprocessor, or the processor may also be any conventional processor or the like.

The apparatus 800 may further include one or more memories 820 storing a program, and the program may be executed by the processor 810 to cause the processor 810 to perform the method described in the foregoing method embodiments. The memory 820 may be separate from the processor 810 or may be integrated into the processor 810.

The apparatus 800 may further include a transceiver 830, and the processor 810 may communicate with another device or chip via the transceiver 830. For example, the processor 810 may perform data transceiving with another device or chip via the transceiver 830.

Embodiments of the present disclosure further provide a computer-readable storage medium storing a program. The computer-readable storage medium may be applied to the terminal device or network device provided in embodiments of the present disclosure, and the program causes a computer to perform the method performed by the terminal device or network device in the embodiments of the present disclosure.

Embodiments of the present disclosure further provide a computer program product. The computer program product includes a program. The computer program product may be applied to the terminal device or network device provided in embodiments of the present disclosure, and the program causes the computer to perform the method performed by the terminal device or network device in the embodiments of the present disclosure.

Embodiments of the present disclosure further provide a computer program. The computer program may be applied to the terminal device or network device provided in embodiments of the present disclosure, and the computer program causes a computer to perform the method performed by the terminal device or network device in the embodiments of the present disclosure.

It should be understood that the terms “system” and “network” in the present disclosure may be used interchangeably. In addition, the terms used in the present disclosure are merely used to explain specific embodiments of the present disclosure and are not intended to limit the present disclosure. In the description, claims, and accompanying drawings of the present disclosure, the terms “first”, “second”, “third”, “fourth”, and the like are used to distinguish different objects rather than describe a specific order. In addition, the terms “including” and “having” and any variations thereof are intended to cover non-exclusive inclusion.

It should be understood that the term “indication” mentioned in the embodiments of the present disclosure may be a direct indication, or may be an indirect indication, or may indicate that there is an association relationship. For example, A indicates B, which may indicate that A directly indicates B, e.g., B is obtained through A, or may indicate that A indirectly indicates B, e.g., A indicates C and B is obtained through C, or may indicate that A and B have an association relationship.

In the embodiments of the present disclosure, “B corresponding to A” indicates that B is associated with A, and B may be determined based on A. However, it should be further understood that, determining B based on A does not mean that B is determined only based on A, but rather B may be determined based on A and/or other information.

In the embodiments of the present disclosure, the term “corresponding” may indicate that there is a direct correspondence or indirect correspondence between the two, or may indicate that there is an association relationship between the two, or may be relationships such as indicating and being indicated, configuring and being configured, etc.

In the embodiments of the present disclosure, the term “including” may refer to directly including or may refer to indirectly including. Optionally, the “including” mentioned in the embodiments of the present disclosure may be replaced with “indicating” or “used for determining”. For example, “A includes B” may be replaced with “A indicates B”, or “A is used to determine B”.

It should be understood that the terms “predefined” and “preconfigured” may be implemented by pre-storing a corresponding code, or a table in a device (e.g., a terminal device and a network device), or another manner that can be used to indicate related information, and a specific implementation thereof is not limited in the present disclosure. For example, the predefined may indicate being defined in a protocol.

It should be understood that the term “protocol” in the embodiments of the present disclosure may refer to a standard protocol in the field of communications, such as an LTE protocol, an NR protocol, and related protocols applied to a future communications system, which is not limited in the present disclosure.

The term “and/or” in the embodiments of the present disclosure is merely an association relationship for describing associated objects, indicating that there may be three types of relationships, e.g., A and/or B may indicate that A exists alone, A and B exist at the same time, and B exists alone. In addition, the character “/” in this specification generally indicates an “or” relationship between the associated objects.

It should be understood that in various embodiments of the present disclosure, a size of a sequence number of each process does not mean an execution sequence, and the execution sequence of each process should be determined by its function and internal logic but should not constitute any limitation on an implementation process of the embodiments of the present disclosure.

In the several embodiments provided in the present disclosure, it should be understood that the disclosed system, apparatus, and method may be implemented in other manners. For example, the apparatus embodiments described above are merely illustrative, and the division of the units is merely a logical function division. In actual implementation, there may be alternative division manners, such as combining a plurality of units or components or integrating them into another system, or ignoring or not executing some features. In addition, the shown or discussed mutual coupling or direct coupling or communication connection may be indirect coupling or communication connection through some interfaces, devices, or units, which may be electrical, mechanical, or in other forms.

The units described as separate parts may or may not be physically separate, and parts shown as units may or may not be physical units, i.e., may be located in one position, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist alone physically, or two or more units are integrated into one unit.

All or some of the foregoing embodiments may be implemented by using software, hardware, firmware, or any combination thereof. When software is used to implement the embodiments, all or some of the embodiments may be implemented in a form of a computer program product. The computer program product includes one or more computer instructions.

When the computer program instructions are loaded and executed on a computer, the procedures or functions according to the embodiments of the present disclosure are all or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium, for example, the computer instructions may be transmitted from a website, a computer, a server, or a data center to another website, computer, server, or data center in a wired (e.g., a coaxial cable, an optical fiber, a digital subscriber line (DSL)) or a wireless (e.g., infrared, wireless, microwave, etc.) manner.

The computer-readable storage medium may be any usable medium readable by a computer, or a data storage device, such as a server or a data center including one or more integrated usable media. The usable medium may be a magnetic medium (e.g., a floppy disk, a hard disk, or a magnetic tape), an optical medium (e.g., a digital video disc (DVD)), a semiconductor medium (e.g., a solid state disk (SSD)), or the like.

The foregoing descriptions are merely specific implementations of the present disclosure, but the protection scope of the present disclosure is not limited thereto, and any changes or substitutions that may be easily conceived of by a person skilled in the art within the technical scope disclosed in the present disclosure should be contained in the protection scope of the present disclosure. Therefore, the protection scope of the present disclosure shall be subject to the protection scope of the claims.

What is claimed is:

1. A positioning method, the method being performed by a positioning apparatus and comprising:
obtaining a first positioning result of a to-be-positioned device; and
determining a first error corresponding to the first positioning result using a first model, and determining a target positioning result for the to-be-positioned device based on the first error;
wherein the first model is used to fit a relationship between a distance and a spatial weight between the to-be-positioned device and an anchor device.

2. The method according to claim 1, wherein the first error is determined according to one or more of: the distance between the to-be-positioned device and the anchor device, the spatial weight between the to-be-positioned device and the anchor device, and an observation error corresponding to the first positioning result.

3. The method according to claim 1, wherein the first error is determined according to a formula:
$${e}_{unkown} = f ( d ) {e}^{T}$$
wherein e_{unkown} represents the first error, f(d) represents the relationship between the distance and the spatial weight between the to-be-positioned device and the anchor device, e represents an observation error vector corresponding to the first positioning result, and e^{T} represents a transposed matrix of e.

4. The method according to claim 3, wherein the observation error vector e is determined according to the distance between the to-be-positioned device and the anchor device and positioning data collected by the to-be-positioned device and the anchor device.

5. The method according to claim 1, wherein the determining the target positioning result for the to-be-positioned device based on the first error includes:
compensating first positioning data corresponding to the first positioning result based on the first error to obtain second positioning data; and
determining the target positioning result using the second positioning data.

6. The method according to claim 5, wherein the first positioning data is obtained by filtering positioning data collected by the to-be-positioned device and the anchor device.

7. The method according to claim 6, wherein the positioning data collected by the to-be-positioned device and the anchor device is obtained using a time of arrival (TOA) positioning method.

8. The method according to claim 1, wherein the target positioning result is determined according to a formula:
$${x}^{( k + 1 )} = {x}^{( k )} + Δ {x}^{( k )}$$
wherein x^{(k+1)} is the target positioning result obtained in a next iteration, x^{(k)} is the target positioning result obtained in a current iteration, Δx^{(k)} is an updated error for the current iteration, and k is a number of iterations; and
wherein the updated error Δx^{(k)} for the current iteration is determined according to a formula:
$$Δ {x}^{( k )} = {( {F}^{′} ( {x}^{( k )} ) )}^{- 1} \cdot ( - F ( {x}^{( k )} ) )$$
wherein F(x(^{k})) is a vector determined based on the distance between the to-be-positioned device and the anchor device, and (F′(x(^{k}))⁻¹ is an inverse of a Jacobian matrix of F(x^{(k)}).

9. A positioning apparatus, comprising a memory and a processor, wherein the memory is configured to store a program, and the processor is configured to invoke the program in the memory to cause the positioning apparatus to perform following operations:
obtaining a first positioning result of a to-be-positioned device; and
determining a first error corresponding to the first positioning result using a first model, and determining a target positioning result for the to-be-positioned device based on the first error;
wherein the first model is used to fit a relationship between a distance and a spatial weight between the to-be-positioned device and an anchor device.

10. The positioning apparatus according to claim 9, wherein the first error is determined according to one or more of: the distance between the to-be-positioned device and the anchor device, the spatial weight between the to-be-positioned device and the anchor device, and an observation error corresponding to the first positioning result.

11. The positioning apparatus according to claim 9, wherein the first error is determined according to a formula:
$${e}_{unkown} = f ( d ) {e}^{T}$$
wherein e_{unkown} represents the first error, f(d) represents the relationship between the distance and the spatial weight between the to-be-positioned device and the anchor device, e represents an observation error vector corresponding to the first positioning result, and e^{T} represents a transposed matrix of e.

12. The positioning apparatus according to claim 11, wherein the observation error vector e is determined according to the distance between the to-be-positioned device and the anchor device and positioning data collected by the to-be-positioned device and the anchor device.

13. The positioning apparatus according to claim 9, wherein the determining the target positioning result for the to-be-positioned device based on the first error includes:
compensating first positioning data corresponding to the first positioning result based on the first error to obtain second positioning data; and
determining the target positioning result using the second positioning data.

14. The positioning apparatus according to claim 13, wherein the first positioning data is obtained by filtering positioning data collected by the to-be-positioned device and the anchor device.

15. The positioning apparatus according to claim 14, wherein the positioning data collected by the to-be-positioned device and the anchor device is obtained using a time of arrival (TOA) positioning method.

16. The positioning apparatus according to claim 9, wherein the target positioning result is determined according to a formula:
$${x}^{( k + 1 )} = {x}^{( k )} + Δ {x}^{( k )}$$
wherein x^{(k+1)} is the target positioning result obtained in a next iteration, x^{(k)} is the target positioning result obtained in a current iteration, Δx^{(k)} is an updated error for the current iteration, and k is a number of iterations; and
wherein the updated error Δx^{(k)} for the current iteration is determined according to a formula:
$$Δ {x}^{( k )} = {( {F}^{′} ( {x}^{( k )} ) )}^{- 1} \cdot ( - F ( {x}^{( k )} ) )$$
wherein F(x(^{k})) is a vector determined based on the distance between the to-be-positioned device and the anchor device, and (F′(x(^{k}))⁻¹ is an inverse of a Jacobian matrix of F(x^{(k)}).

17. The positioning apparatus according to claim 9, wherein the first model is a spatial neural network model.

18. The positioning apparatus according to claim 9, wherein the first positioning result is determined using a positioning technology based on a mobile communication network.

19. The positioning apparatus according to claim 9, wherein the positioning apparatus is used for indoor positioning.

20. The positioning apparatus according to claim 9, wherein the positioning apparatus further performs following operation:
notifying parameters of the first model to the to-be-positioned device or the anchor device, wherein the parameters of the first model are used for the to-be-positioned device or the anchor device to perform positioning estimation.
